(19) United States
(12) Patent Application Publication
(10) Pub. No.: US 2013/0177431 A1
(43) Pub. Date: Jul. 11, 2013

(54) MULTI-MATERIAL ROTOR, A STEAM TURBINE HAVING A MULTI-MATERIAL ROTOR AND A METHOD FOR PRODUCING A MULTI-MATERIAL ROTOR

(71) Applicants: Thomas Joseph FARINEAU, Schoharie, NY (US); Robin Carl SCHWANT, Pattersonville, NY (US)

(72) Inventors: Thomas Joseph FARINEAU, Schoharie, NY (US); Robin Carl SCHWANT, Pattersonville, NY (US)

(73) Assignee: GENERAL ELECTRIC COMPANY, Schenectady, NY (US)

(21) Appl. No.: 13/344,703

(22) Filed: Jan. 6, 2012

(51) Int. Cl. F01D 5/14; B23P 15/04

(52) U.S. Cl. 416/223 R; 29/889.2

(57) ABSTRACT

A multi-material rotor, a super-critical steam turbine having a multi-material rotor, and a method of producing a multi-material rotor are disclosed. The rotor includes a shaft high temperature section having a first end and a second end. The shaft high temperature section is made up of at least three different materials.

### FIELD OF THE INVENTION

The present invention is generally directed to steam turbines, and more specifically directed to a steam turbine having a multi-material rotor shaft for exposure to supercritical steam.

### BACKGROUND OF THE INVENTION

A typical steam turbine plant may be equipped with a high pressure steam turbine, an intermediate pressure steam turbine and a low pressure steam turbine. Each steam turbine is formed of materials appropriate to withstand operating conditions, pressure, temperature, flow rate, etc., for that particular turbine.

Recently, steam turbine plant designs directed toward a larger capacity and a higher efficiency have been designed that include steam turbines that operate over a range of pressures and temperatures. The designs have included high-low pressure integrated, high-intermediate-low pressure integrated, and intermediate-low pressure integrated steam turbine rotors integrated into one piece and using the same metal material for each steam turbine. Often, a metal is used that is capable of performing in the highest of operating conditions for that turbine, thereby increasing the overall cost of the turbine.

A steam turbine conventionally includes a rotor and a casing jacket. The rotor includes a rotatably mounted turbine shaft that includes blades. When heated and pressurized steam flows through the flow space between the casing jacket and the rotor, the turbine shaft is set in rotation as energy is transferred from the steam to the rotor. The rotor, and in particular the rotor shaft, often forms the bulk of the metal of the turbine. Thus, the metal that forms the rotor significantly contributes to the cost of the turbine. If the rotor is formed of a high cost, high temperature metal, the cost is even further increased. When manufacturing components of high temperature material, such as turbine rotors, forming large single-piece components results in expensive components, extended manufacturing time and such manufacturing capacity is often limited. In addition, large high temperature component forgings are often not required throughout the steam path, resulting in an inefficient use of expensive high temperature materials.

Accordingly, it would be desirable to provide a steam turbine rotor formed of smaller high temperature material components, having material that is less expensive on a per pound basis than a single forging and has greater ease of manufacture than known in the art for single-component rotor forgings and component sections formed of materials tailored for steam conditions present in the various sections of the steam turbine.

### SUMMARY OF THE INVENTION

According to an exemplary embodiment of the present disclosure, a rotor is disclosed that includes a shaft high temperature section having a first end and a second end. The shaft high temperature section is made up of at least three different materials.

According to another exemplary embodiment of the present disclosure, a steam turbine is disclosed that includes a rotor. The rotor includes a shaft high temperature section having a first end and a second end. The shaft high temperature section is made up of at least three different materials.

According to another exemplary embodiment of the present disclosure, a method of making a multi-material rotor is disclosed. The method includes providing a plurality of high pressure sections and joining the plurality of high pressure sections to form a shaft high temperature section. The shaft high temperature section is made up of at least three different materials.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a sectional view of a steam turbine according to the present disclosure.

Wherever possible, the same reference numbers will be used throughout the drawings to represent the same parts.

### DETAILED DESCRIPTION OF THE INVENTION

The present disclosure now will be described more fully hereinafter with reference to the accompanying drawings, in which an exemplary embodiment of the disclosure is shown. This disclosure may, however, be embodied in many different forms and should not be construed as limited to the embodiments set forth herein.

Provided is a sectioned steam turbine rotor formed of smaller forgings of high temperature material than known in the art, having material that is less expensive on a per pound basis than a single forging. In addition, component sections formed of materials tailored for steam conditions present in the various sections of the steam turbine are provided in the present disclosure. The multi-material rotor arrangement according to the present disclosure enables the use of less high temperature material than conventionally present in conventional steam turbine rotors. The multi-material components permit the tailoring or matching of steam conditions to the materials exposed, permitting efficient use of expensive high temperature material. In addition, the smaller forgings have a greater ease of manufacture than known in the art for single-component rotor forgings. In addition, the smaller forgings may have shorter delivery cycles and enable more efficient manufacturing. In some embodiment, the sectioned rotor includes components that can be disassembled for maintenance and/or repair. In addition, the multi-material rotor permits a variable or tailored material makeup of the rotor that closely corresponds to the rotor conditions without complicated forging or manufacturing techniques.

In embodiments of the present disclosure, the system configuration provides a means to produce a large rotor that could not be produced as a single high temperature piece. Another advantage is that the system configuration provides a lower cost steam turbine rotor. Another advantage of an embodiment of the present disclosure includes reduced manufacturing time as the lead time for procuring a multi-material rotor is less than that of a rotor forged from a single-piece forging of high temperature material, such as nickel-based superalloys. Embodiments of the present disclosure allow the fabrication of a high pressure, intermediate pressure or high pressure/intermediate pressure rotor from a series of smaller forgings made from the same material that are either a) less expensive on a per pound basis than a single forging or b) offer a time savings in terms of procurement cycle vs. a moderate size one-piece forging. Such arrangements provide less expensive manufacturing.

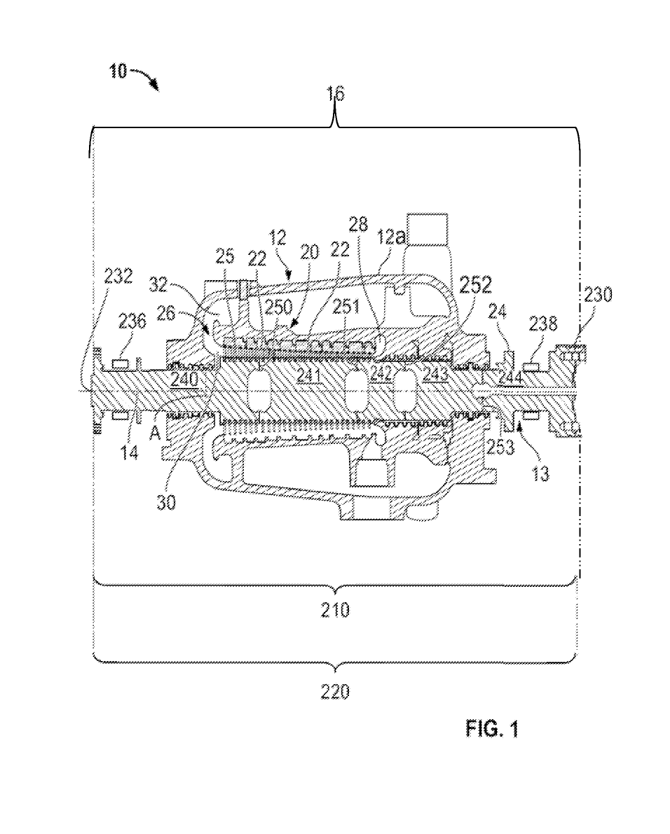

FIG. 1 illustrates a sectional diagram of a steam turbine 10 according to an embodiment of the disclosure. The steam turbine 10 includes a casing 12 in which a turbine rotor 13 is mounted rotatably about an axis of rotation 14. The steam turbine 10 includes a high pressure (HP) section 16.

The steam turbine 10 operates at super-critical operating conditions. In one embodiment, the high pressure section 16 of steam turbine 10 receives steam at a pressure above about 220 bar. In another embodiment, the high pressure section 16 receives steam at a pressure between about 220 bar and about 340 bar. In another embodiment, the high pressure section 16 receives steam at a pressure between about 220 bar to about 240 bar. Additionally, the high pressure section 16 receives steam at a temperature between about 590° C. and about 760° C. In another embodiment, the high pressure section 16 receives steam at a temperature between about 590° C. and about 625° C.

The casing 12 includes an HP casing 12a. The HP casing 12a are separate components, or, in other words, are not integral. In this exemplary embodiment, the HP casing 12a is a double-wall casing. The casing 12 includes a housing 20 and a plurality of guide vanes 22 attached to the housing 20. The rotor 13 includes a shaft 24 and a plurality of blades 25 fixed to the shaft 24. The shaft 24 is rotatably supported by a first bearing 236, a second bearing 238, and third bearing 264.

A main steam flow path 26 is defined as the path for steam flow between the casing 12 and the rotor 13. The main steam flow path 26 includes an HP main steam flow path section 30 located in the turbine HP section 16. As used herein, the term “main steam flow path” means the primary flow path of steam that produces power.

Steam is provided to an HP inflow region 28 of the main steam flow path 26. The steam flows through the HP main steam flow path section 30 of the main steam flow path 26 between vanes 22 and blades 25, during which the steam expands and cools. Thermal energy of the steam is converted into mechanical, rotational energy as the steam rotates the rotor 13 about the axis 14. After flowing through the HP main steam flow path section 30, the steam flows out of an HP steam outflow region 32 into an intermediate superheater (not shown), where the steam is heated to a higher temperature. Additional thermal energy of the steam is converted into mechanical, rotational energy as the steam rotates the rotor 13 about the axis 14. The steam may be used in other operations, not illustrated in any more detail.

In another embodiment, the steam turbine 10 includes an intermediate pressure (IP) section downstream of a similarly configured HP section, where the temperature range is substantially identical to the temperature range of the HP section (e.g., about 590° C. to about 760° C.), but with lower pressure. For example, pressures for the IP section may be from about 30 bar to about 100 bar.

As can further be seen in FIG. 1, the rotor 13 includes a rotor HP section 210 located in the turbine HP section 16. The rotor 13 includes a shaft 24. Correspondingly, the shaft 24 includes a shaft high temperature section 220 located in the turbine HP section 16. The shaft high temperature section 220 can be joined, for example, at a bolted joint 230 to other components such as an IP section or other suitable turbine component. In another embodiment, the shaft HP 220 can be joined to other components by welding, bolting, or other joining technique.

The shaft high temperature section 220 may be joined to another component (not shown) at the first end 232 of the shaft 24 by a bolted joint, a weld, or other joining technique. In another embodiment, the shaft high temperature section 220 may be bolted to a generator at the first end 232 of shaft 24.

The shaft high temperature section 220 includes a first HP section 240, a second HP section 241, a third HP section 242, a fourth HP section 243 and a fifth HP section 244. In another embodiment, the shaft high temperature section 220 may include more than three HP section or more than five HP sections. The shaft high temperature section 220 is rotatably supported by a first bearing 236 (FIG. 1) and a second bearing 238 (FIG. 1). In an embodiment, for example, the first bearing 236 may be a journal bearing. In another embodiment, the second bearing 238 may be a thrust/journal bearing. In another embodiment, different support bearing configurations may be used. The first bearing 236 supports the first HP section 240, and the second bearing 238 supports the fifth HP section 244.

The first and third HP sections 240, 242 are joined to the second HP section 241 by a first and a second welds 250, 251, respectively. The third and fifth HP sections 242, 244 are joined to the fourth HP section 243 by a third and a fourth weld 252, 253, respectively. In another embodiment, the first, second, third and/or fourth welds 250, 251, 252, 253 may be replaced with bolted joints. In this exemplary embodiment, the first, second and third welds 250, 251, 252 are located along the HP main steam flow path section 30 (FIG. 1) and the fourth weld 253 is located outside or not in contact with the HP main steam flow path section 30. In another embodiment, the first weld 250 may be located outside or not in contact with the HP main steam flow path section 30. In an embodiment, the first weld 250 may be located at position “A” (FIG. 1) outside and not in contact with the HP main steam flow path section 30, but may be in contact with seal steam leakage.

The third HP section 242 at least partially defines the HP inflow region 28 and HP main steam flow path section 30. The second HP section 241 at least partially defines the HP main steam flow path section 30. The first HP section 240 further at least partially defines the HP main steam flow path section 30 and the seal steam leakage. As discussed above, in another embodiment, the first weld 250 may be moved so that the first HP section 240 does not at least partially define the HP main steam flow path section 30. The fourth and fifth HP sections 243, 244 do not at least partially define the main steam flow path 26, or, in other words, the fourth and fifth HP sections 243, 244 are outside of the HP main steam flow path section 30 and do not contact the main steam flow path 26.

The third HP section 242 is formed of single, unitary sections or blocks of a first high temperature resistant material. The first high temperature resistant material may be referred to as a first high temperature material. The third HP section may be joined to the other HP sections or blocks by a material joining technique, such as, but not limited to, welding and bolting.

While the above arrangement of first HP section 240, second HP section 241, third HP section 242, fourth HP section 243 and fifth HP section 244 for the shaft high temperature section 220 has been described with respect to the turbine HP section 16, the multi-material rotor may be an IP section rotor, wherein the IP section rotor has an arrangement of a plurality of multi-material sections, as disclosed for the HP section discussed above.

The first high temperature material, for example, in third HP section 242 is a nickel-based superalloy. In an embodiment, the high temperature material may be a nickel-based superalloy including an amount of chromium (Cr), molybdenum (Mo), columbium (Cb) and nickel (Ni) as remainder. In an embodiment, the high temperature material may be a nickel-based superalloy including an amount of chromium (Cr), molybdenum (Mo), columbium (Cb) and nickel (Ni) as remainder. In an embodiment, the high temperature material may be a nickel-based superalloy including 16-25 wt % of Cr, up to 15 wt % of Co, 4-12 wt % of Mo, up to 6 wt % of Cb, 0.3-4.0 wt % of Ti, 0.05-3.0 wt % of Al, up to 0.04 wt % of B, up to 10 wt % of Fe and balance Ni and incidental impurities.

In another embodiment the high temperature material may be a nickel-based superalloy including 16-25 wt % of Cr, 4-12 wt % of Mo, 1.0-6.0 wt % of Cb, 0.3-4.0 wt % of Ti, 0.05-1.0 wt % of Al, up to 10 wt % of Fe, and balance Ni and incidental impurities. In another embodiment, the nickel-based superalloy includes 18-23 wt % of Cr, 6-9 wt % of Mo, 2.0-5.0 wt % of Cb, 0.6-3.0 wt % of Ti, 0.05-0.5 wt % of Al, 2-7 wt % of Fe, and balance Ni and incidental impurities. In still another embodiment, the nickel-based superalloy includes 19-22 wt % of Cr, 6.5-8.0 wt % of Mo, 3.0-4.5 wt % of Cb, 1.0-2.0 wt % of Ti, 0.1-0.3 wt % of Al, 3.0-5.5 wt % of Fe, and balance Ni and incidental impurities.

In another embodiment the high temperature material may be a nickel-based superalloy including 16-24 wt % of Cr, 5-15 wt % of Co, 5-12 wt % of Mo, 0.5-4.0 wt % of Ti, 0.3-3.0 wt % of Al, 0.002-0.04 wt % of B, and balance Ni and incidental impurities. In another embodiment, the nickel-based superalloy includes 18-22 wt % of Cr, 8-12 wt % of Co, 6-10 wt % of Mo, 1.0-3.0 wt % of Ti, 0.8-2.0 wt % of Al, 0.002-0.02 wt % of B, and balance Ni and incidental impurities. In still another embodiment, the nickel-based superalloy includes 19-21 wt % of Cr, 9-11 wt % of Co, 7-9 wt % of Mo, 1.7-2.5 wt % of Ti, 1.2-1.8 wt % of Al, 0.002-0.01 wt % of B, and balance Ni and incidental impurities.

In one embodiment, second and fourth HP sections 241 and 243 are formed of single, unitary sections or blocks of a second high temperature resistant material. The second high temperature resistant material may be referred to as a second high temperature material. In another embodiment, the HP sections may be formed of one or more HP sections or blocks of high temperature material that are joined together by a material joining technique, such as, but not limited to, welding and bolting. The second and fourth HP sections 241 and 243 may be formed of the same HTM. In another embodiment, the second and fourth HP sections 241 and 243 are formed of different HTMs.

In an embodiment, the second high temperature material is a high-chromium alloy steel. In another embodiment, the second high temperature material may be a steel including an amount of chromium (Cr), molybdenum (Mo), vanadium (V), manganese (Mn), and cobalt (Co). In an embodiment, the high temperature material may be a high-chromium alloy steel including 0.1-1.2 wt % of Mn, up to 1.5 wt % of Ni, 8.0-15.0 wt % of Cr, up to 4.0 wt % of Co, 0.5-3.0 wt % of Mo, 0.05-1.0 wt % of V, 0.02-0.5 wt % of Cb, 0.005-0.15 wt % of N, up to 0.04 wt % of B, up to 3.0 wt % of W, and balance Fe and incidental impurities.

In another embodiment the second high temperature material may be a high-chromium alloy steel including 0.2-1.2 wt % of Mn, 9.0-13.0 wt % of Cr, 0.5-3.0 wt % of Mo, 0.05-1.0 wt % of V, 0.02-0.5 wt % of Cb, 0.02-0.15 wt % of N, and balance Fe and incidental impurities. In another embodiment, the high-chromium alloy includes 0.3-1.0 wt % of Mn, 10.0-11.5 wt % of Cr, 0.7-2.0 wt % of Mo, 0.05-0.5 wt % of V, 0.02-0.3 wt % of Cb, 0.02-0.10 wt % of N, and balance Fe and incidental impurities. In still another embodiment, the high-chromium alloy includes 0.4-0.9 wt % of Mn, 10.4-11.3 wt % of Cr, 0.8-1.2 wt % of Mo, 0.1-0.3 wt % of V, 0.04-0.15 wt % of Cb, 0.03-0.09 wt % of N, and balance Fe and incidental impurities.

In another embodiment the second high temperature material may be a high-chromium alloy steel including 0.2-1.2 wt % of Mn, 0.2-1.5 wt % of Ni, 8.0-15.0 wt % of Cr, 0.5-3.0 wt % of Mo, 0.05-1.0 wt % of V, 0.02-0.5 wt % of Cb, 0.02-0.15 wt % of N, 0.2-3.0 wt % of W, and balance Fe and incidental impurities. In another embodiment, the high-chromium alloy includes 0.2-0.8 wt % of Mn, 0.4-1.0 wt % of Ni, 9.0-12.0 wt % of Cr, 0.7-1.5 wt % of Mo, 0.05-0.5 wt % of V, 0.02-0.3 wt % of Cb, 0.02-0.10 wt % of N, 0.5-2.0 wt % of W, and balance Fe and incidental impurities. In still another embodiment, the high-chromium alloy includes 0.3-0.7 wt % of Mn, 0.5-0.9 wt % of Ni, 9.9-10.7 wt % of Cr, 0.9-1.3 wt % of Mo, 0.1-0.3 wt % of V, 0.03-0.08 wt % of Cb, 0.03-0.09 wt % of N, 0.9-1.2 wt % of W, and balance Fe and incidental impurities.

In another embodiment the second high temperature material may be a high-chromium alloy steel including 0.1-1.2 wt % of Mn, 0.05-1.00 wt % of Ni, 7.0-11.0 wt % of Cr, 0.5-4.0 wt % of Co, 0.5-3.0 wt % of Mo, 0.1-1.0 wt % of V, 0.02-0.5 wt % of Cb, 0.005-0.06 wt % of N, 0.002-0.04 wt % of B, and balance Fe and incidental impurities. In another embodiment, the high-chromium alloy includes 0.1-0.8 wt % of Mn, 0.08-0.4 wt % of Ni, 8.0-10.0 wt % of Cr, 0.8-2.0 wt % of Co, 1.0-2.0 wt % of Mo, 0.1-0.5 wt % of V, 0.02-0.3 wt % of Cb, 0.01-0.04 wt % of N, 0.005-0.02 wt % of B, and balance Fe and incidental impurities. In still another embodiment, the high-chromium alloy includes 0.2-0.5 wt % of Mn, 0.08-0.25 wt % of Ni, 8.9-9.7 wt % of Cr, 1.1-1.5 wt % of Co, 1.3-1.7 wt % of Mo, 0.15-0.3 wt % of V, 0.04-0.07 wt % of Cb, 0.014-0.032 wt % of N, 0.007-0.014 wt % of B, and balance Fe and incidental impurities.

In one embodiment, first and fifth HP sections 240 and 244 are formed of single, unitary sections or blocks of a lower temperature resistant material. The first and fifth HP sections 240 and 244 may be formed of a less heat resistant material than the high-chromium alloy steel as described above. The less heat resistant material may be referred to as a lower temperature material (LTM). In another embodiment, the HP sections may be formed of one or more HP sections or blocks of lower temperature material that are joined together by a material joining technique, such as, but not limited to, welding and bolting. The first and fifth HP sections 240 and 244 may be formed of the same LTM. In another embodiment, the first and fifth HP sections 240 and 244 are formed of different LTM.

The lower temperature material may be a low alloy steel. In an embodiment, the lower temperature material may be a CrMoVNi alloy steel. In an embodiment, the lower temperature material may be a low alloy steel including 0.05-1.5 wt % of Mn, 0.1-3.0 wt % of Ni, 0.05-5.0 wt % of Cr, 0.2-4.0 wt % of Mo, 0.05-1.0 wt % of V, up to 3.0 wt % of W and balance Fe and incidental impurities.

In another embodiment the lower temperature material may be a low alloy steel including 0.3-1.2 wt % of Mn, 0.1-1.5 wt % of Ni, 0.5-3.0 wt % of Cr, 0.4-3.0 wt % of Mo, 0.05-1.0 wt % of V, and balance Fe and incidental impurities. In another embodiment, the low alloy steel includes 0.5-1.0 wt % of Mn, 0.2-1.0 wt % of Ni, 0.6-1.8 wt % of Cr, 0.7-2.0 wt % of Mo, 0.1-0.5 wt % of V, and balance Fe and incidental impurities. In still another embodiment, the low alloy steel includes 0.6-0.9 wt % of Mn, 0.2-0.7 wt % of Ni, 0.8-1.4 wt % of Cr, 0.9-1.6 wt % of Mo, 0.15-0.35 wt % of V, and balance Fe and incidental impurities.

In another embodiment the lower temperature material may be a low alloy steel including 0.2-1.5 wt % of Mn, 0.2-1.6 wt % of Ni, 1.0-3.0 wt % of Cr, 0.2-2.0 wt % of Mo, 0.05-1.0 wt % of V, 0.2-3.0 wt % of W and balance Fe and incidental impurities. In another embodiment, the low alloy steel includes 0.4-1.0 wt % of Mn, 0.4-1.0 wt % of Ni, 1.5-2.7 wt % of Cr, 0.5-1.2 wt % of Mo, 0.1-0.5 wt % of V, 0.4-1.0 wt % of W and balance Fe and incidental impurities. In still another embodiment, the low alloy steel includes 0.5-0.9 wt % of Mn, 0.6-0.9 wt % of Ni, 1.8-2.4 wt % of Cr, 0.7-1.0 wt % of Mo, 0.2-0.4 wt % of V, 0.5-0.8 wt % of W and balance Fe and incidental impurities.

In another embodiment the lower temperature material may be a low alloy steel including 0.05-1.2 wt % of Mn, 0.5-3.0 wt % of Ni, 0.05-5.0 wt % of Cr, 0.5-4.0 wt % of Mo, 0.05-1.0 wt % of V, and balance Fe and incidental impurities. In another embodiment, the low alloy steel includes 0.05-0.7 wt % of Mn, 1.0-2.0 wt % of Ni, 1.5-2.5 wt % of Cr, 1.0-2.5 wt % of Mo, 0.1-0.5 wt % of V, and balance Fe and incidental impurities. In still another embodiment, the low alloy steel includes 0.1-0.3 wt % of Mn, 1.3-1.7 wt % of Ni, 1.8-2.2 wt % of Cr, 1.5-2.0 wt % of Mo, 0.15-0.35 wt % of V, and balance Fe and incidental impurities.

The shaft 24 may be produced by an embodiment of a method of manufacturing as described below. The shaft high temperature section 220 may be produced by joining first HP section 240 to second HP section 241, joining second HP section 241 to third HP section 242, joining third HP section 242 to fourth HP section 243 and joining fourth HP section 243 to fifth HP section 244.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A multi-material rotor, comprising:
a shaft high temperature section having a first end and a second end;
wherein the shaft high temperature section is made up of at least three different materials.

2. The multi-material rotor of claim 1, wherein the shaft high temperature section comprises:
a first high pressure section;
a second high pressure section, the second high pressure section joined to the first high pressure section;
a third high pressure section, the third high pressure section joined to the second high pressure section;
a fourth high pressure section, the fourth high pressure section joined to the third high pressure section; and
a fifth high pressure section, the fifth high pressure section joined to the fourth high pressure section.

3. The multi-material rotor of claim 2, wherein at least one of the first, second, third, fourth and fifth high pressure sections is formed of a nickel-based superalloy.

4. The multi-material rotor of claim 3, wherein at least one of the first, second, third, fourth and fifth high pressure sections is formed of a high-chromium alloy steel.

5. The multi-material rotor of claim 4, wherein at least the first and fifth high pressure sections are formed of a low alloy steel, the second and fourth high pressure sections are formed of a high-chromium alloy steel and the third high pressure section is formed of a nickel-based superalloy.

6. The multi-material rotor of claim 1, wherein the rotor is an intermediate pressure rotor.

7. The multi-material rotor of claim 6, wherein the intermediate pressure rotor is made up of a plurality of rotor sections.

8. The multi-material rotor of claim 7, wherein the intermediate pressure rotor is made up of at least three different materials.

9. A steam turbine, comprising:
a multi-material rotor, comprising:
a shaft high temperature section having a first end and a second end;
wherein the shaft high temperature section is made up of at least three different materials.

10. The steam turbine of claim 9, wherein the shaft high temperature section comprises:
a first high pressure section;
a second high pressure section, the second high pressure section joined to the first high pressure section;
a third high pressure section, the third high pressure section joined to the second high pressure section;
a fourth high pressure section, the fourth high pressure section joined to the third high pressure section; and
a fifth high pressure section, the fifth high pressure section joined to the fourth high pressure section.

11. The steam turbine of claim 10, wherein at least one of the first, second, third, fourth and fifth high pressure sections is formed of a nickel-based superalloy.

12. The steam turbine of claim 11, wherein at least one of the first, second, third, fourth and fifth high pressure sections is formed of a high-chromium alloy steel.

13. The steam turbine of claim 12, wherein at least the first and fifth high pressure sections are formed of a low alloy steel, the second and fourth high pressure sections are formed of a high-chromium alloy steel and the third high pressure section is formed of a nickel-based superalloy.

14. The steam turbine of claim 9, wherein the multi-material rotor is an intermediate pressure section rotor.

15. The steam turbine of claim 9, wherein an intermediate pressure section rotor is attached to the second end.

16. The steam turbine of claim 15, wherein the intermediate pressure section rotor is made up of at least three different materials.

17. A method of making a multi-material rotor comprising:
providing a plurality of high pressure sections; and
joining the plurality of high pressure sections to form a shaft high temperature section;
wherein the shaft high temperature section is made up of at least three different materials.

18. The method of claim 17, wherein the at least three different materials include a nickel-based superalloy, a high-chromium alloy steel, and a low alloy steel.

19. The method of claim 17, wherein the multi-material rotor is an intermediate pressure rotor.

20. The method of claim 17, further comprising attaching an intermediate pressure section rotor to the shaft high temperature section.
